(19) United States
(12) Patent Application Publication
(10) Pub. No.: US 2003/0121640 A1
(43) Pub. Date: Jul. 3, 2003

(54) Heating and/or air conditioning system

(76) Inventors: Joachim Currle, Stuttgart (DE); Frank Fruehauf, Aichwald (DE); Juergen Wertenbach, Fellbach (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/301,824

(22) Filed: Nov. 22, 2002

(30) Foreign Application Priority Data
Nov. 23, 2001 (DE) 101 57 497.5

(51) Int. Cl. B60H 3/00; B61D 27/00; F28F 13/12; F28F 19/00

(52) U.S. Cl. 165/42; 165/43; 165/119

(57) ABSTRACT

A heating and/or air-conditioning system for the interior of a vehicle has an air-conveying device, a heat exchanger and an evaporator. At least one air-conveying assembly of the air-conveying device is designed as a disc fan so that the heating and/or air-conditioning system can have as compact a build as possible and so as to achieve high efficiency.

### This application claims the priority of German application 101 57 497.5, filed Nov. 23, 2001, the disclosure of which is expressly incorporated by reference herein.

Reference is also made to co-pending U.S. Patent application Ser. No. ______, titled HEATING AND/OR AIR-CONDITIONING SYSTEM WITH VENTILATION AND EVACUATION, filed on the same date as the present application.

### BACKGROUND AND SUMMARY OF THE INVENTION

The present invention relates to a heating and/or air-conditioning system for a vehicle interior including an air-conveying device, a heat exchanger, and an evaporator for conditioning of air. The air-conveying device conveys at least one of fresh air, sucked in from outside, and circulating air, sucked in from the vehicle interior, into the inside of the vehicle via at least one of the heat exchanger and the evaporator and at least one air duct.

In practice, such heating and/or air-conditioning systems have to fulfil certain minimum requirements with regard to the air quantity to be conveyed and in terms of a small construction space. Since a radial fan has properties which, along with a small volume, are conducive to high air conveyance, heating and/or air-conditioning systems have one or more radial fans.

Thus, German publication DE 37 38 425 A1 discloses an air-conditioning apparatus for motor vehicles, with a heating body, an evaporator and a fan. The fan is designed as a radial fan which, for reasons of space, is surrounded radially by the heating body. This design is relatively complicated in structural terms.

European publication EP 0 529 099 B1 discloses a disc-type fan. This disc-type fan has a set of a plurality of parallel discs which are driven by a motor. The disadvantage of such a disc-type fan is that it has only low efficiency and therefore requires a relatively high drive power.

One object on which the invention is based is to provide a heating and/or air-conditioning system for a vehicle interior, which takes up a small amount of construction space and is set up in a simple way in structural terms. In particular, a heating and/or air-conditioning system which has high efficiency, particularly during air conveyance, is to be provided.

This object is achieved, according to the invention, by way of a heating and/or air-conditioning system in which the air-conveying device has a disc fan.

A heating and/or air-conditioning system according to the invention has an air-conveying device with one or more air-conveying assemblies. At least one air-conveying assembly is designed as what is known as a disc fan. The disc fan has a set of a plurality of parallel discs which are arranged with a small clearance next to one another on a shaft and are driven jointly by a drive motor. It was shown, surprisingly, that the design of an air-conveying assembly as a disc fan does not yield any disadvantages in terms of construction volume and/or efficiency, but affords some advantages. The disc fan operates very quietly, so that noise-insulating measures can be reduced or dispensed with completely. By contrast, in the case of the radial fan normally used, noise-insulating measures are obligatory. However, such measures take up additional construction space and have considerable air resistance, so that, overall, the efficiency is adversely influenced.

Depending on requirements, the disc fan may be designed either as a centrally sucking-in and tangentially blowing-out air-conveying assembly or as a tangentially sucking-in and tangentially blowing-out air-conveying assembly. This makes it possible to dispense with additional air-deflecting measures, since the disc fan can be adapted to the necessary air-conveying directions. The necessary length of the air ducts and the number of turns which entail loss can therefore be reduced.

It is also advantageous that the conveying direction of the disc fan can be changed over. By changing the direction of rotation of the disc set, the conveying direction of the disc fan can be reversed. Thus, simply by a change in direction of rotation, the disc fan can be used for aerating and/or deaerating a vehicle interior.

In one version, there is provision, in particular, for the disc fan to be designed for drying the evaporator. In the cooling mode, condensation water is precipitated on the evaporator, so that the latter becomes moist and, after the cooling mode is switched off, moisture may be transferred by the air stream into the vehicle. In order to prevent this, there is provision, by a reversal of the conveying direction, for the disc fan to be used in order to dry the evaporator. In this case, the disc fan extracts dry air from the vehicle interior and guides it through the evaporator into the open, the evaporator being dried at the same time. The disc fan may in this case be arranged downstream or upstream of the evaporator.

The disc fan may also be designed for drying an air filter. Air-conditioning systems often have an air filter in order to purify air which is sucked in. If the sucked-in air is moist, for example when there is rain or mist, the air filter becomes wet through and bacteria which are harmful to health and/or produce odors may form in the filter. By reversing the conveying direction of the disc fan, the air filter can be dried and its moisture discharged outwards, so that an infestation of the air filter with germs is avoided or at least inhibited.

In a particularly advantageous version, the disc fan, in addition to the function of air conveyance and/or air deflection, may also have at least one further function. Thus, the construction space taken up by the heating and/or air-conditioning system can be reduced even further.

Thus, there may be provision for the disc fan to be designed as a water separator. Fresh air is sucked in by the heating and/or air-conditioning system via a fresh-air suction orifice which issues into a water box for the separation of entrained water droplets. The water box usually has a plurality of air-guide elements which deflect the air and separate entrained water. As a result of the air deflection, such a water box has high air resistance and takes up a large amount of construction space. There is provision for arranging the disc fan for air conveyance and water separation in the region of the water box. As a result of the rotation of the discs, the disc fan separates the conveyed air from entrained water particles. The water box can be dispensed with completely or have at least a very much more compact design.

In one version, there is provision for arranging one or more disc fans in the vehicle interior as decentral fans. In particular, the disc fans may be designed for the circulation of circulating air, each disc fan circulating circulating air in the form of a closed roller in the vehicle interior.

In an advantageous version, the disc fan is designed as a heat exchanger for heating and/or cooling, in that the disc fan has heatable and/or coolable discs. The discs have intimate contact with the air, so that the resistance of the heat flow from the rotating discs to the air is very low. Due to the high rotational speed of the discs, good heat transmission between the discs and the air is obtained. By virtue of specific heating or cooling of individual discs of the disc fan, the air can be heated or cooled quickly and efficiently.

In an advantageous version, there is provision for designing the disc fan as an air filter for the purification of air, in that the discs of the disc fan have a preferably adsorbing or ionizing coating. The coating can have, for example, activated charcoal, in order to adsorb odors or gases.

Further features and embodiments of the invention may be gathered from the claims, the figures and the figure descriptions. The features and feature combinations mentioned above and listed below can be used not only in the combination specified in each case but also in other combinations or alone, without departing from the scope of the invention.

Further versions of the invention are illustrated in and explained by way of the figures.

### BRIEF DESCRIPTION OF THE DRAWINGS

FIG. 1 shows a heating and/or air-conditioning system in an interior of a motor vehicle,

FIG. 2 is a perspective view of a disc fan with a central air suction orifice and a tangential air blow-out orifice,

FIG. 3 is a sectional illustration of the disc fan with a central air suction orifice and a tangential air blow-out orifice,

FIG. 4 is a side view of a disc fan with a tangential air suction orifice and a tangential air blow-out orifice, and

FIG. 5 is a sectional illustration of the disc fan with a tangential air suction orifice and a tangential air blow-out orifice.

### DETAILED DESCRIPTION OF THE INVENTION

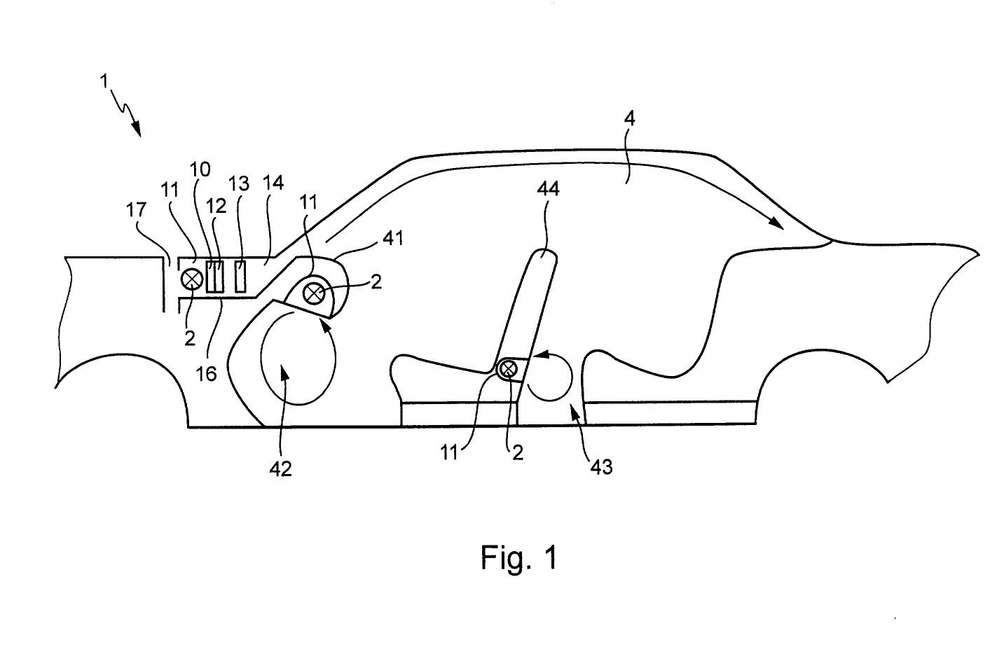

FIG. 1 illustrates a heating and/or air-conditioning system 1 for the vehicle interior 4 in a passenger car. An air-conditioning housing 16 is arranged in the engine space of the passenger car and contains an air filter 10, an evaporator 12, a heat exchanger 13 and a disc-type fan 2, also designated as a disc fan 2, which belongs to an air-conveying device 11. The disc fan 2 is arranged in the air-conditioning housing 16 upstream of the air filter 10 and conveys outside air into the vehicle interior 4, this outside air being sucked into the air-conditioning housing 16 through a water box 17. The water box 17 separates water entrained with the outside air and has a water outflow at its lower end.

Outside air is sucked in by the disc fan 2 and conveyed through the air filter 10 and/or the evaporator 12 and/or the heat exchanger 13 into an air distribution system having one or more air ducts 14 which lead into the vehicle interior 4.

Arranged in the front region of the vehicle interior 4 is an instrument panel 41 which extends over the width of the vehicle interior and upwardly delimits a driver leg room or front-passenger leg room. A driver's seat 44 and a front passenger's seat 44 arranged next to it divide the vehicle interior 4 into a front section with driver and front-passenger leg room 42 and a rear section with rear leg room 43.

A disc fan 2 of the air-conveying device 11 is installed, concealed, in the region of the instrument panel 41 and circulates circulating air in the adjacent drive or front-passenger leg room 42 in the form of a closed roller. A further disc fan 2 is installed, concealed, in the driver's seat or front passenger's seat 44 and circulates circulating air in the rear leg room 43 in the form of a closed roller.

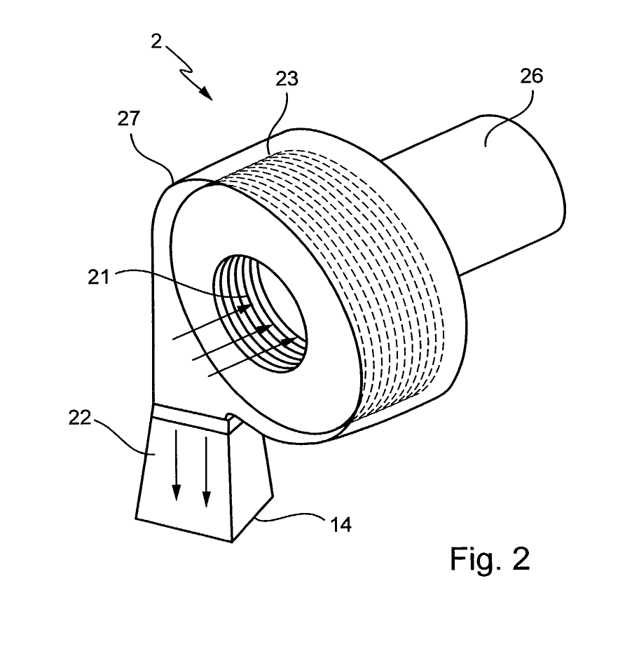

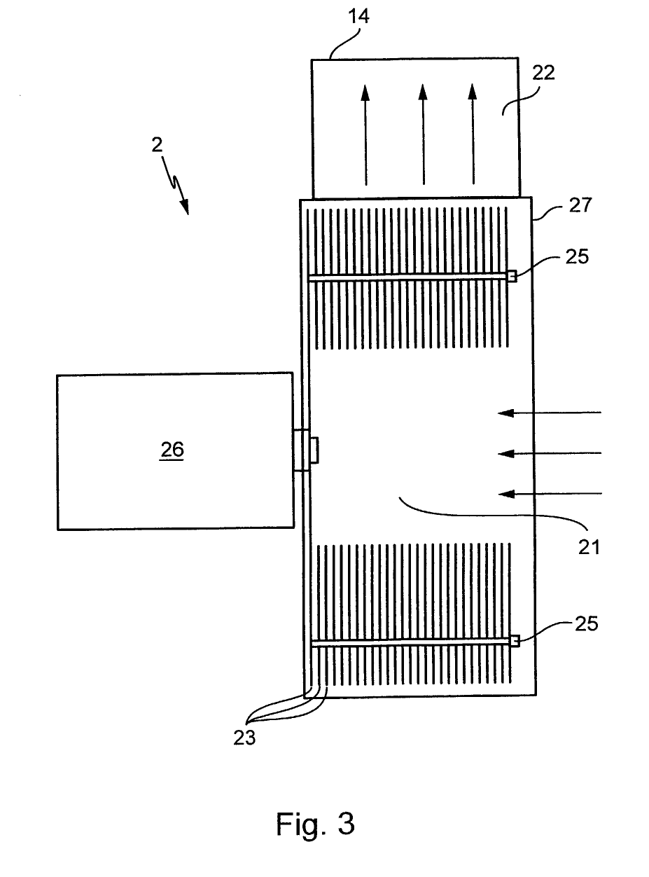

The set-up of the disc fans 2 is illustrated in the further figures. FIG. 2 shows a perspective illustration and FIG. 3 a sectional illustration of a disc fan 2 with a central suction direction and a tangential conveying direction. The disc fan 2 has a housing 27, in which a set of a plurality of round discs 23 is mounted rotatably. The discs 23 are arranged parallel to one another with a clearance and are connected to one another via screws 25. The discs may also be connected to one another by adhesive bonding or joining together or soldering instead of via screws. An air gap is formed in each case between two discs 23. Depending on the desired conveying quantity, the disc set of the disc fan 2 may have about 20 to 100 discs. It was shown that a disc thickness of 0.2 mm to 1 mm and a disc clearance of 2 mm to 8 mm, along with a disc diameter of 5 cm to 30 cm, are ideal.

The first disc 23 in the disc set is a solid disc and is connected fixedly in terms of rotation to a drive motor 26. The remaining discs 23 of the set have a concentric cutouts which serve as an air suction orifice 21. An air outlet orifice 22 is arranged in the housing 27 tangentially to the discs 23.

The electric drive motor 26 sets the set of discs 23 in rotation. Owing to the wall friction, the air is set in rotation and is conveyed radially outwards from the central suction orifice 21 by the centrifugal forces. It flows through the outlet orifice 22 out of the housing 27 into an air duct 14 adjoining the housing 27.

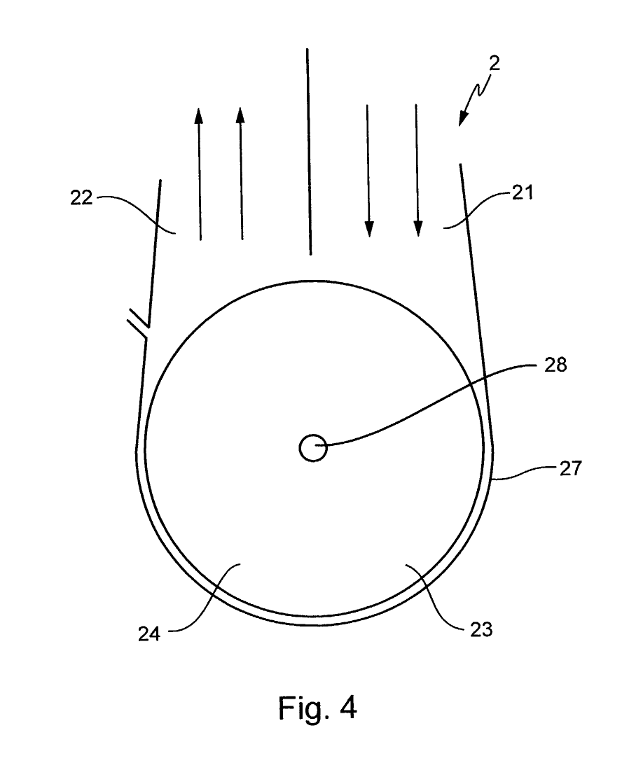

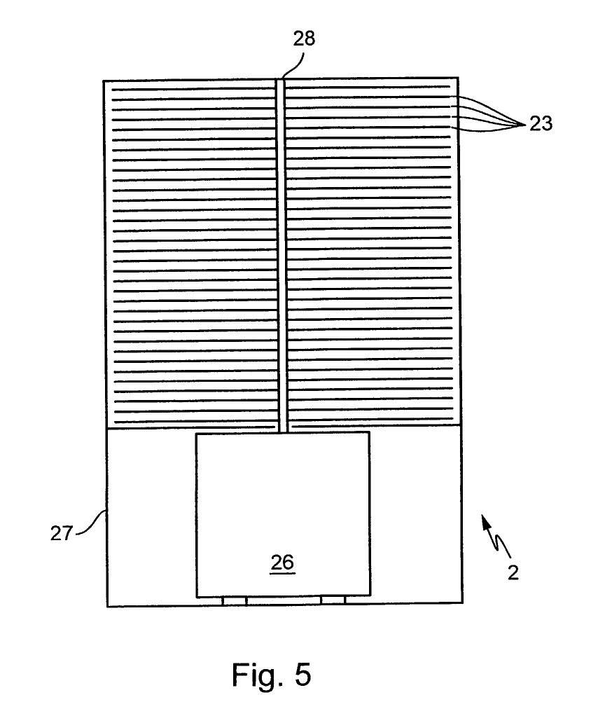

FIG. 4 shows a top view and FIG. 5 shows a sectional illustration of the set-up of the disc fan 2 with a tangential suction orifice and a tangential blow-out orifice. As in the set-up described in FIGS. 2 and 3, the disc fan 2 has a housing 27, in which a set of a plurality of round discs 23 is mounted rotatably. The discs 23 are arranged parallel to one another with a clearance and are connected to one another via screws 25. An air gap is formed in each case between two discs 23. The disc set of the disc fan 2 may have about 20 to 100 discs, depending on the desired conveying quantity. It was shown that a disc thickness of 0.2 mm to 1 mm and a disc clearance of 2 mm to 8 mm, along with a diameter of 5 cm to 30 cm, are ideal.

In contrast to the set-up shown in FIGS. 2 and 3, here all the discs 23 are made solid without a cutout, are arranged on a common shaft 28 and are connected fixedly in terms of rotation to one another.

A drive motor 26 drives the shaft 28 and thus sets the set of discs 23 in rotation.

The housing 27 has, on one side, two cutouts which are separated from one another by a partition. One of the cutouts is designed as suction orifice 21 and the other cutout is designed as a blow-out orifice 22. The suction orifice 21 and the blow-out orifice 22 lie in a common plane. This means that the disc fan changes the direction of the conveyed air stream by up to 180□. Versions may also be envisaged in which the disc fan changes the direction of the conveyed air by less than 180□.

The discs 23 of the disc fan have a coating 24 which is designed for purifying the air and contains, as an active component, activated charcoal for the adsorption of harmful gases. Individual discs 23 are designed as Peltier elements, so that they can be heated and/or cooled electrically in order to heat or cool the air stream.

As a result of the rotating movement of the discs 23, centrifugal forces arise in the disc fan 2, which act on water particles and/or dust particles possibly present in the air stream and separate these from the air stream. The disc fan may therefore advantageously be used as a water separator and/or dust filter in the vehicle.

Air conveyance via the rotating discs 23 of the disc fan 2 is very quiet. The disc fan 2 may advantageously be used without further noise-insulating measures in the vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We Claim

1. A heating and/or air-conditioning system for a vehicle interior, comprising:
an air-conveying device,
a heat exchanger, and
an evaporator for conditioning of air,
wherein the air-conveying device conveys at least one of fresh air sucked in from outside and circulating air sucked in from the vehicle interior into the inside of the vehicle via at least one of the heat exchanger and the evaporator, and at least one air duct, and
wherein the air-conveying device has a disc fan.

2. The heating and/or air-conditioning system according to claim 1, wherein the disc fan is designed as a tangentially sucking-in and tangentially conveying air-conveying assembly having an air inlet orifice and an air outlet orifice which lie in one plane.

3. The heating and/or air-conditioning system according to claim 1, wherein the disc fan is designed as an axially sucking-in and tangentially conveying air-conveying assembly having an air inlet orifice and an air outlet orifice oriented at right angles to one another.

4. The heating and/or air-conditioning system according to claim 1, wherein the disc fan can be used selectively for at least one of aerating and deaerating the vehicle interior by changing over its conveying direction.

5. The heating and/or air-conditioning system according to claim 1, and further comprising an air filter for purification of air, wherein the disc fan is designed for drying at least one of the evaporator and the air filter, and wherein the disc fan is arranged downstream or upstream of at least one of the evaporator and the air filter, so that, with conveyance being reversed, the disc fan acts upon the evaporator or air filter with air sucked in from the vehicle interior and discharges moisture present on the evaporator or air filter outwards.

6. The heating and/or air-conditioning system according to claim 1, wherein the disc fan is designed as a water separator which separates by rotation water drops entrained in the air.

7. The heating and/or air-conditioning system according to claim 1, wherein the disc fan is designed as a dust filter which separates by rotation dust particles entrained in the air.

8. The heating and/or air-conditioning system according to claim 1, wherein the disc fan is designed as a separate fan in the vehicle interior which circulates circulating air in the form of a roller closed on itself.

9. The heating and/or air-conditioning system according to claim 1, wherein the disc fan is one of a plurality of preferably interacting disc fans.

10. The heating and/or air-conditioning system according to claim 1, wherein the disc fan is designed as a heat exchanger having a ring-type heat exchanger engaging into discs, electrically conductive discs, or electrically heatable discs with an electrically conductive coating.

11. The heating and/or air-conditioning system according to claim 1, wherein the disc fan is designed as an air filter having discs coated with a functional layer having at least one of adsorbing and ionizing properties.

12. The heating and/or air-conditioning system according to claim 2, wherein the disc fan is designed as a water separator which separates by rotation water drops entrained in the air.

13. The heating and/or air-conditioning system according to claim 2, wherein the disc fan is designed as a dust filter which separates by rotation dust particles entrained in the air.

14. The heating and/or air-conditioning system according to claim 2, wherein the disc fan is designed as a separate fan in the vehicle interior which circulates circulating air in the form of a roller closed on itself.

15. The heating and/or air-conditioning system according to claim 2, wherein the disc fan is one of a plurality of preferably interacting disc fans.

16. The heating and/or air-conditioning system according to claim 2, wherein the disc fan is designed as a heat exchanger having a ring-type heat exchanger engaging into discs, electrically conductive discs, or electrically heatable discs with an electrically conductive coating.

17. The heating and/or air-conditioning system according to claim 2, wherein the disc fan is designed as an air filter having discs coated with a functional layer having at least one of adsorbing and ionizing properties.

18. The heating and/or air-conditioning system according to claim 3, wherein the disc fan is designed as a water separator which separates by rotation water drops entrained in the air.

19. The heating and/or air-conditioning system according to claim 3, wherein the disc fan is designed as a dust filter which separates by rotation dust particles entrained in the air.

20. The heating and/or air-conditioning system according to claim 3, wherein the disc fan is designed as a separate fan in the vehicle interior which circulates circulating air in the form of a roller closed on itself.

21. The heating and/or air-conditioning system according to claim 3, wherein the disc fan is one of a plurality of preferably interacting disc fans.

22. The heating and/or air-conditioning system according to claim 3, wherein the disc fan is designed as a heat exchanger having a ring-type heat exchanger engaging into discs, electrically conductive discs, or electrically heatable discs with an electrically conductive coating.

23. The heating and/or air-conditioning system according to claim 3, wherein the disc fan is designed as an air filter having discs coated with a functional layer having at least one of adsorbing and ionizing properties.

24. The heating and/or air-conditioning system according to claim 2, wherein the disc fan can be used selectively for at least one of aerating and deaerating the vehicle interior by changing over its conveying direction.

25. The heating and/or air-conditioning system according to claim 2, and further comprising an air filter for purification of air, wherein the disc fan is designed for drying at least one of the evaporator and the air filter, and wherein the disc fan is arranged downstream or upstream of at least one of the evaporator and the air filter, so that, with conveyance being reversed, the disc fan acts upon the evaporator or air filter with air sucked in from the vehicle interior and discharges moisture present on the evaporator or air filter outwards.

26. The heating and/or air-conditioning system according to claim 3, and further comprising an air filter for purification of air, wherein the disc fan is designed for drying at least one of the evaporator and the air filter, and wherein the disc fan is arranged downstream or upstream of at least one of the evaporator and the air filter, so that, with conveyance being reversed, the disc fan acts upon the evaporator or air filter with air sucked in from the vehicle interior and discharges moisture present on the evaporator or air filter outwards.

27. The heating and/or air-conditioning system according to claim 4, and further comprising an air filter for purification of air, wherein the disc fan is designed for drying at least one of the evaporator and the air filter, and wherein the disc fan is arranged downstream or upstream of at least one of the evaporator and the air filter, so that, with conveyance being reversed, the disc fan acts upon the evaporator or air filter with air sucked in from the vehicle interior and discharges moisture present on the evaporator or air filter outwards.
